(19) United States
(12) Patent Application Publication
(10) Pub. No.: US 2016/0071197 A1
(43) Pub. Date: Mar. 10, 2016

(54) System and Method to Facilitate On-Line Ordering

(71) Applicant: VETZ PETZ LTD., Dover, DE (US)

(72) Inventor: David Elsworth, Queenscliff NSW (AU)

(21) Appl. No.: 14/848,206

(22) Filed: Sep. 8, 2015

Related U.S. Application Data
(60) Provisional application No. 62/047,632, filed on Sep. 8, 2014.

(51) Int. Cl. G06Q 30/06; G06Q 30/02

(52) U.S. Cl. CPC G06Q 30/0641; G06Q 30/0224

(57) ABSTRACT

A system and method facilitates continued purchases of goods convenient to a customer, while maintaining a connection to a source provider. The system and methods permit the customer to identify a referring party to receive a discount and provide rewards back to the referring party. The system may for example permit the search, selection, and purchase of goods, track purchases of goods, permit the referring party to communicate with a customer, provide historic purchasing information to either the customer or referring party, present a unique interface to the customer associated with the referring party, interface with one or more systems of the referring party or intermediary such as a distributor to facilitate the selection, purchase, filling, sending, or receipt of the purchased goods, and any combination thereof.

### PRIORITY

This application claims the benefit of U.S. Provisional Application No. 62/047,632, filed Sep. 8, 2014, which is incorporated by reference herein in its entirety.

### BACKGROUND

There are a number of professions in which a professional may render services and provide goods simultaneously. After the services are rendered, the customer may then seek to replenish the goods at a cheaper price without having to re-engage the professional. In a number of cases, the customer will be able to find a cheaper price by simply searching on-line and finding a distributor, and cutting out the professional.

### BRIEF SUMMARY

Embodiments described herein establish a system and method for tracking customers who are provided with a unique identification code from a referring party. This system permits the referring party to be paid a commission/margin on sales or provided another reward or incentive, while the customer gets the autonomy to shop without the interference of the referring party or may receive their own incentive, discount, or reward. The system shares the value with referring parties (especially professional advisors) who ordinarily loose ongoing income once a customer has left their practice and shops on-line.

### BRIEF DESCRIPTION OF THE DRAWINGS

FIG. 1 illustrates an exemplary process according to embodiments described herein.

FIG. 2 illustrates an exemplary method of navigating the system according to embodiments described herein.

FIG. 3 illustrates an exemplary process according to embodiments described herein.

FIG. 4 illustrates a diagram of an embodiment of a client-server network environment to implement the on-line ordering system according to embodiments described herein.

### DETAILED DESCRIPTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. It should be understood that the drawings are diagrammatic and schematic representations of exemplary embodiments of the invention, and are not limiting of the present invention nor are they necessarily drawn to scale.

Exemplary embodiments are described herein in terms of veterinary services and associated goods for pets. However, it should be understood that embodiments of this invention are not so limited, but are additionally applicable to other professional services or industries in which goods are sold to a customer, and then may be found elsewhere by the customer without intervention of the professional. For example, other industries may include doctors, cosmetic and personal care industries and professionals, among others. Furthermore, although embodiments of the invention may be described and illustrated herein in terms of a website application, it should be understood that embodiments of the invention are also applicable to other interfaces, such as mobile applications, portals, dedicated electronic devices, and configurations in which a consumer may place an order through an interface communicating through a network to a host system.

In an exemplary embodiment (but not exclusive to the vet business), veterinary professionals are set up with a personal code unique to their practice (and/or to the individual vets within the practice). These codes may be provided physically (card/coupon) or online (downloadable or electronic) from the vet professional to the customer. The code may also be a number already associated with the vet, such as an address number or telephone number. A customer then inputs the code into a user interface of a sales website (or at the vet clinic by the vet professional/vet nurse) to receive discounts off the recommended retail price (RRP). The product is then delivered to the customer. A commission may also be rebated to the vet professional and/or customer. The system enables a single product or a portfolio of products to be managed and sold to customers with income being shared back to the referring professional who established the initial relationship with the customer.

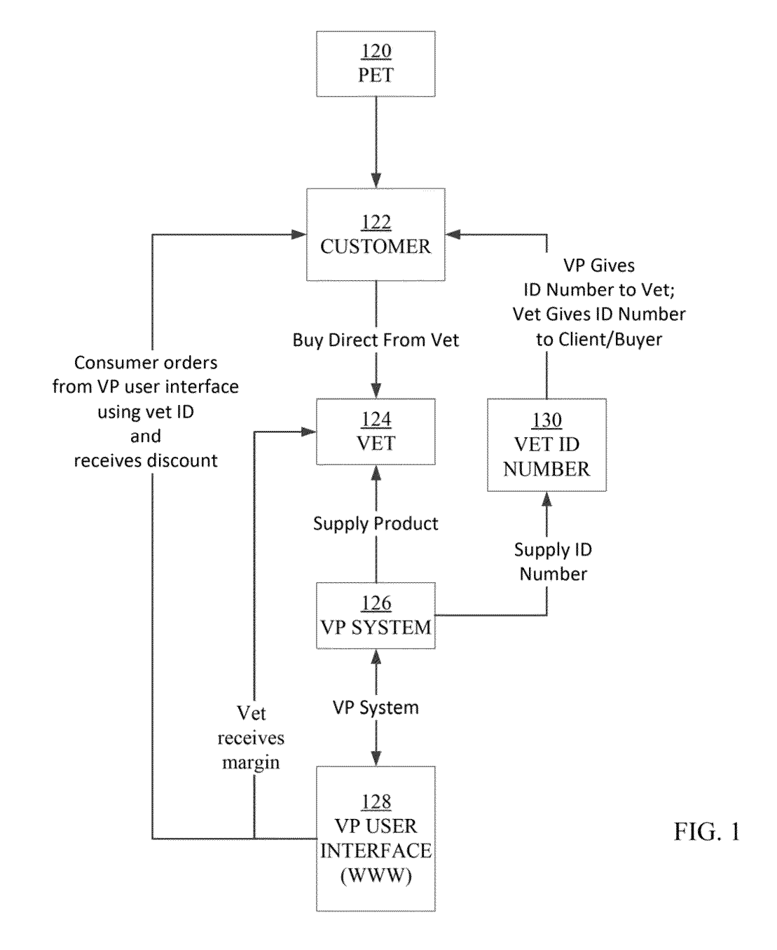

FIG. 1 illustrates an exemplary block diagram of how users and portions of the system interact according to exemplary embodiments described herein. Exemplary embodiments permit a consumer to receive a recommendation to purchase a product through an online portal, where the referring party receives a commission when the consumer makes a purchase through the portal.

First, the PET 120 is taken by the CUSTOMER 122 to the VET 124. When receiving veterinary services, the customer may be sold goods associated with the service. Alternatively, the veterinarian may simply make goods available for sale at their location. The CUSTOMER 122 may therefore purchase a product sold by the VET 124. Products may include medications, food, cleaning or care products, collars, wearables, or other goods supported by the veterinarian office. In the typical transaction at the veterinarian location, the vet receives a margin on the purchase. The seller of the good may pay the vet to locate items within their store, or otherwise pay a commission to the vet on any items sold from their location.

Through the system user interface 128, the vet may resupply the product by requesting a refill through the system 126. The vet may therefore keep a continued supply of products for purchase at their location. The vet 124 may also or alternatively retrieve or submit an identifier number 130 that corresponds to the veterinary location and/or veterinarian. Once the veterinary location is confirmed and/or identified as a user of the system, the veterinarian/veterinary location may receive a VET ID NUMBER to provide to the customer. In an exemplary embodiment, the VET ID NUMBER is the phone number of the practice for ease of remembering by the consumer. The vet may then provide this ID NUMBER to the consumer identifying the customer as authorized by the vet and/or the practice to use the system 126.

A unique identifier may be provided per customer such that veterinarian or practice receives a new identifier for each customer introduced to the system. Alternatively, the veterinarian or practice may be provided a single identifier that is provided to each customer such that all of the customers of a given practice have the same identifier. In either case, the identifier provided to the consumer is associated with the veterinarian and/or practice. The identifier may be selected by the vet or the practice or by the system. In an exemplary embodiment, the unique identifier for the practice is the phone number of the practice. Individual unique identifiers may then be created per veterinarian within the practice by appending a prefix or suffix number to the practice unique number. For example, the veterinary practice may have a unique identifier 123 555 5555 corresponding to the veterinarian phone number, while a veterinarian within the practice may have the identifier 123 555 5555 1.

The system user interface 128 is then used by the customer 122 to log into the system interface and place an order for the product. The customer is prompted to enter the provided identifier such that when a purchase is made, a commission or credit may be associated or paid to the veterinarian or practice. The customer may be provided an incentive, such as a discount off of the retail price in order to facilitate the transaction and identify the referring veterinarian or practice. Therefore, the next time the consumer wants to buy the product, they can do so online via a website at a discounted price, while the referring party receives a continued benefit from the transaction.

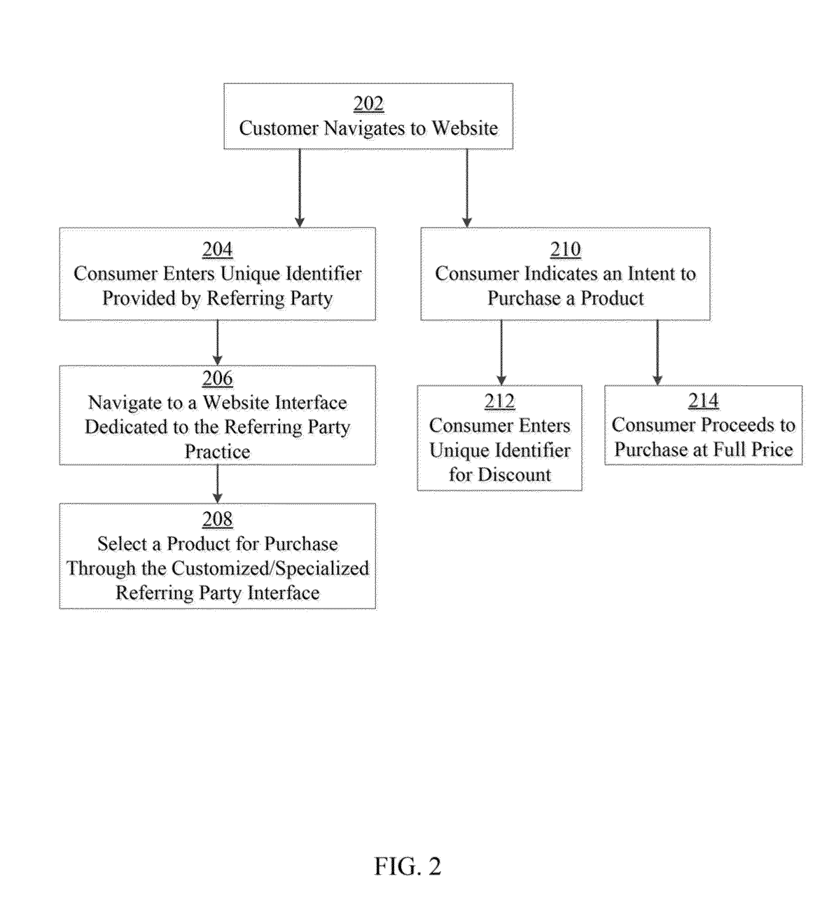

FIG. 2 illustrates an exemplary method of navigating the system in which a consumer may purchase products originally referred by the veterinarian. Once receiving a unique identifier or other input to the system, the customer may use a browser or mobile application to navigate to an interface for placing an on-line order. The interface may be through a mobile application downloaded or executed from a mobile device that communicates with a remote computer or server over a network. The interface may also be through a website executed through a web browser that communicates over a wired or wireless network to a remote server or computer.

At step 202, a customer may navigate to a user interface, such as a website for entering and retrieving information. The website may include selectable inputs or options for the consumer to choose, or may display information for the consumer to view on a screen. The information may include various items for purchase and/or identifications of one or more veterinarian or practice that supports or works with the site to repurchase or recommend goods.

In an exemplary embodiment, the website includes an input for the consumer to enter their unique identifier that associates the consumer to a specific veterinarian or practice. At step 204, the consumer enters the number into the system. At step 206, the website navigates to a second interface specifically tailored or related to the veterinarian or practice associated with the unique identifier provided by the consumer. Therefore, the website may navigate to any one of a number of alternate pages associated with a specific veterinarian or practice to which the customer is related, as identified through the input received from the customer. The custom website may be customizable by the associated veterinarian or practice, or may be a general page hosted by the seller, but using the identifiers, such as names, addresses, contact information, etc. to specifically identify or associate a respective page to an individual veterinarian or practice. The page may otherwise be a generic or general page with layout being one or more selectable templates available or common to one or more other veterinarians or practices. Thus, the unique websites may be fully customizable, limited customizable, or generic. The unique websites associated with individual veterinarians or practices may be distinct in identifying the associated veterinarian or practices, describing the respective veterinarian or practice, offering one or more select items for sale or brands of items for sale, or providing other unique information, links, advice, etc.

At step 208, the customer may select a desired product for repurchase through the unique interface of the associated veterinarian or practice. The goods may be offered at a discount to encourage the customer to use or re-use the system for their goods purchases. As the consumer is associated with the referring veterinarian or practice through the unique identifier entered at step 204, any purchases made by the customer may be credited toward that veterinarian or practice, such that the veterinarian or practice may receive a reward from the seller. Rewards may be through commission on sales, discounts on their own repurchase of products, or other incentive or entitlement programs.

At the website interface at step 202, the customer may also be presented with one or more items for purchase. The items may be searchable, selectable, or presently viewable, such that the customer may make one or more item selections and purchases from one or more available products. The system may use a search engine for the customer to find specific products. The system may also use shopping carts or other indicators for a customer to make purchasing multiple items at once possible. At step 210, the customer indicates which products to purchase and indicates the intent to consummate the transaction. At step 212, the system may prompt the customer or permit the customer to enter their unique identifier provided by the veterinarian/practice to receive a discount on one or more selected items. The customer may also proceed at step 214 by not entering the unique identifier to purchase the product at full price. Therefore, any customer regardless of whether they are referred or related to a referring veterinarian/practice may take advantage of purchasing products through the seller's website.

The system may be configured to present any combination of the described embodiments such as permitting both the customizable option for veterinarian/practice websites as suggested through steps 204, 206, and 208, or for general shopping and purchasing such as suggested by steps 210, 212, and 214. Any combination of the disclosed steps, methods, features, and embodiments may be combined in any sub-combination such as by duplicating, removing, combining, or separating any feature, step, or function described or suggested herein.

Because of the association between the customer and the referring party, the referring party may receive information back regarding the purchasing of the customer. For example, the referring party may receive reports or notices when a customer makes a recurring purchase. The veterinarian or practice may therefore be able to track or identify attributes associated with their practice that may inform the interactions and/or services they provide the customer when they return for the veterinarian services. For example, if the customer is purchasing food for a pet, the general recurrence of orders may be observed by the customer and/or referring veterinarian. When the customer returns to the veterinarian for a check-up visit, the veterinarian can see changes in the repurchase schedule of the customer and ask appropriate questions regarding the health of the animal associated with diet or appetite. For instance, if the purchasing of food generally occurs for a certain quantity at monthly intervals but then changes to every other month intervals, the veterinarian can ask about a reduced appetite in the animal.

The system may be customizable by either the veterinarian/practice and/or the customer such that the shared information may be selected to relevant products and behaviors, and/or preserve the privacy interests of the customer. The system may be configured to provide select reports to the veterinarian automatically, periodically, or upon request by either the customer or veterinarian/practice. The reports may be sent electronically, viewed electronically (such as pdf or tiff or through a website or app display), or made available for print out such that the customer and/or veterinarian/practice can share the information during an actual services visit. The displayed information may be selected such that only chosen purchases or attributes are observable. For example, only a quantity recurrence may be displayed, while the price is disregarded or only purchases for food items are displayed, while suppressing purchases for toys or other items.

Embodiments described herein permit a customer to navigate to a website to purchase goods after being referred by a referring party. The referring party may provide the customer with an identifier to authorize the customer to receive the benefits of the website purchase, such as discounts or other incentives. The identifier may be unique to the referring party such that customers may be associated with the referring party. The customers associated with a referring party may therefore be tracked or identified such that the referring party may receive benefits for making the reference for the customer purchases. The identifier may also be used to provide information about customer purchases to the referring party, such as product preferences, recurrence of purchases, types of products, etc. The identifier and/or customer interaction with the system may uniquely identify the customer. For example, a specific identifier unique to the customer and/or referring party may be used, or specific log-in or credential may be used to separately identify a customer apart from the identifier associating the customer to a referring party. If the customer is uniquely identified, then specific purchasing information may be provided to or about the customer such that the referring party may be informed about specific attributes of their purchases relevant to their services rendered to the customer.

The identifier may be used to determine the discount provided a customer. For example, veterinarians or practices that are able to refer more customers to a site may receive larger discounts for their customers. Alternatively, the provided discount may be related to the return or benefit given the veterinarian/practice such that a veterinarian/practice may dictate or suggest a discount that results in a reward system beneficial to the referring veterinarian/practice.

Accordingly, in an exemplary embodiment, when a customer navigates to a website. The site selections available to a customer may depend on country regulations or the design of the system or associated services or practices that provide the referrals. The customer enters the site and then, depending on the country regulations of the consumer, they either enter the identifier provided by the referring party or they press the buy button on the opening page. If the customer enters the identifier, the system will send them to a page dedicated to associated with the referring party (a sub-site if you will, describing the referring party) where the customer can purchase the desired product by pressing the buy button. The customer may then be taken to a shopping cart where they are given a percentage discount for using the identifier. If the customer presses the buy button, the system then navigates to a page that asks them to enter the identifier to get their discount. The customer can then choose to ignore the prompt and still buy the product at full retail, or enter the number to receive the discount.

In an exemplary embodiment, the platform can retrieve user location information from the device sending the request to access the user interface. Once the geographic location is known, the platform can determine what, if any, regulations are in place for providing on-line sales options to a user. The platform can then select which user interface to present to the user first to comply with the requisite regulations, while maintaining the benefits described herein.

The seller of the goods that host the website are then able to track purchases related to any given referring party and provide the associated party an appropriate incentive. For example, the incentive may be a commission or margin of the purchase price, which may or may not consider the discount provided the customer.

In exemplary embodiments, the system may be configured to provide the referring party with multiple reports on the buying processes of their customers. In exemplary embodiments, the referring party may communicate via the website with customers as a group, such as through the dedicated page of the referring party, or individually, such as when the customer is uniquely identified. The communications may be, for example, related to the services provided by the referring party. In the veterinarian example, the veterinarian may provide information to customers about check-ups, or suggestions for products based on seasons, events. Therefore, a veterinarian may alert a customer through the website that flea season or worm season is approaching and that appropriate products or precautions should be taken.

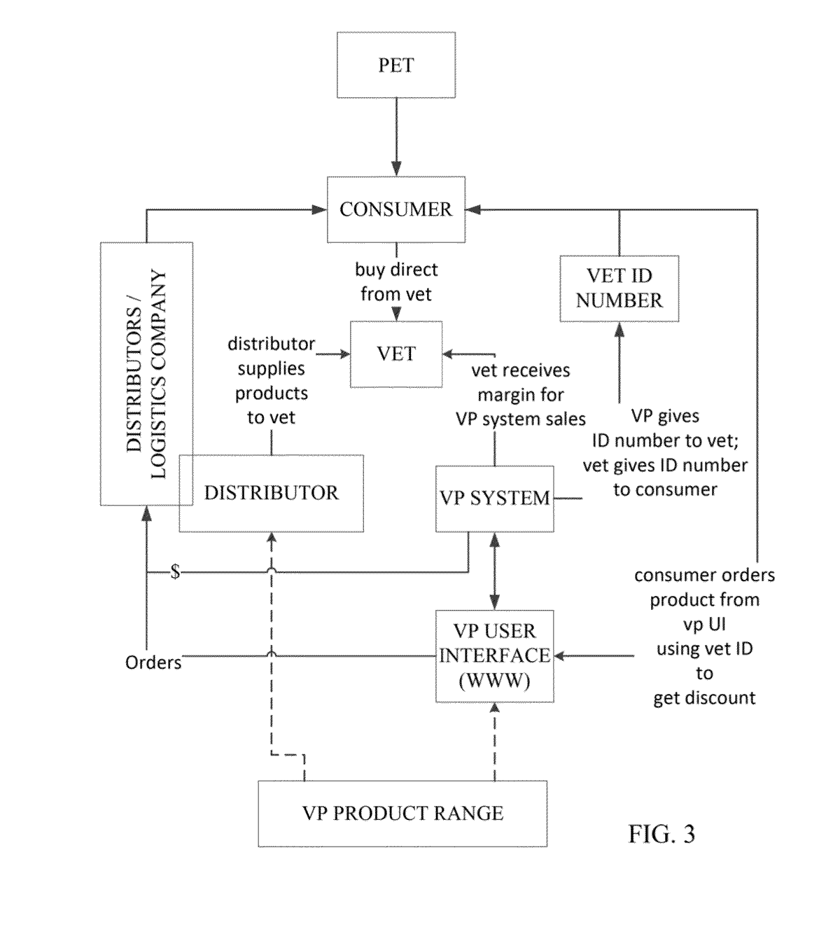

The system and methods described herein also works if a distributor is included. The distributor or agent can be identified by the same or different unique identifier also. FIG. 3 illustrates an exemplary method in which a distributor is used to supply the referring party and/or the customer after purchasing from the website. In this case, when the referring party, such as a veterinarian, orders through the website, a distributor may be provided the order to fill and send to the veterinarian office. Similarly, when the customer orders through the website, a distributor may be provided the order to fill and send to the customer. The distributors for the customer and/or veterinarian may be the same or different.

In an exemplary embodiment, the system may interface with the distributor and/or referring party systems such that filling and receiving orders, and/or providing reports or information about purchases may be efficiently handled and paid for. For example, the process may also work in conjunction with a logistics company back end. Features or interfaces between systems may permit the sending/receiving of orders, shipping details, shipping or ordering terms, invoices, payment, etc.

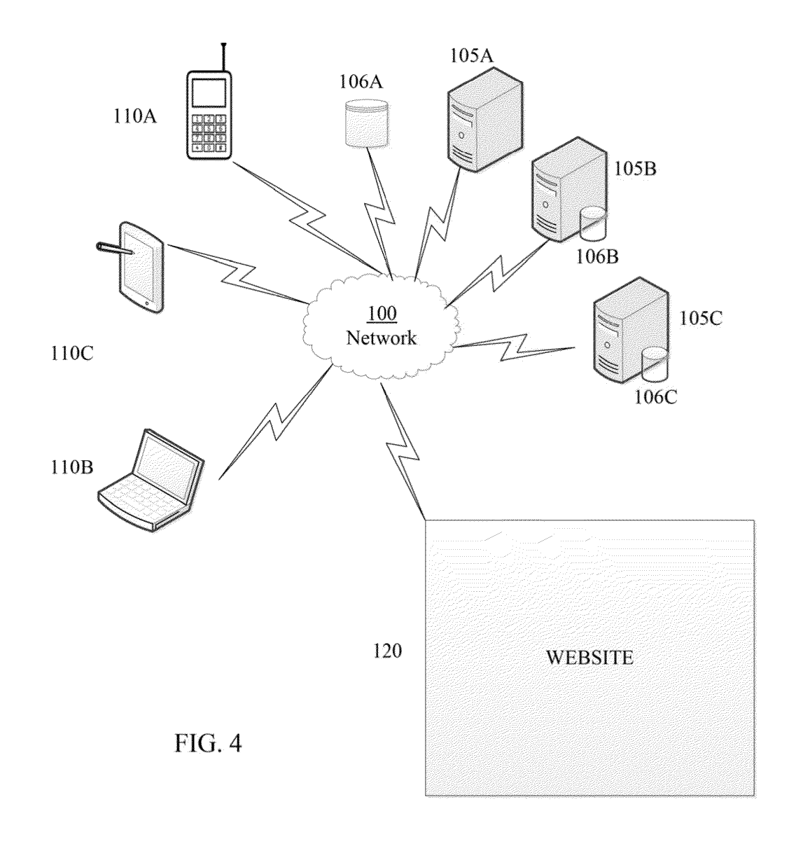

FIG. 4 illustrates a diagram of an embodiment of a client-server network environment to implement the on-line ordering system according to embodiments described herein. An application resident on the client device 110A-110C communicates over a network 100 with one or more servers 105A-105C and their databases 106A-106C. This client device-server system is configured to enable a user of the client device 110A-110C to implement the on-line purchasing system, including, but not limited to, searching for products, selecting products for purchase, receiving information about products, and purchasing products, or any combination thereof. The client devices such as a smart phone 110A, personal digital assistant/tablet 110B, laptop computer 110C may have a browser to execute the application or may have a resident application executed by the client device scripted to run the on-line purchasing system and cooperate or communicate with a remote server or computer.

A database, such as a first database 106A, maintains a database for storing one or more attributes of the on-line purchasing system. When the server 105A is an internet site, the server may be comprised of at least one or more servers and cooperating databases. This new, simple, on-line ordering platform enables anyone to shop and purchase goods while rewarding a referring party. One or more modules, such as a client application on the mobile client device or server applet resident on the server, may be configured to present an interface to support the intake and output of information for one or more of the functions described herein. The client application may have code scripted to present one or more user interface templates that may be user customizable, have one or more prompted input fields, and/or is configured to work with a browser and a remote server. The server applet works with a browser application resident on the client device and serves one or more web pages to the client device with the resident browser.

Referring to FIG. 4, each client device 110A-110C can communicate the content entered into the various user interface fields to set or populate one or more attributes of the database over the network to the server 105A-105C potentially located on the World Wide Web. A software program resident on the server, such as the first server 105A, takes in the entered details. The backend server aggregates the information. The aggregated information is passed to the database. The database may receive, store, and disseminate information, such as, for example, about the referring party, regarding the dedicated interface of a referring party, available goods for sale, the purchasing history of a customer, customer details, etc. The server may be used to communicate and update information stored in the database and communicate to or with one or more associated users in response to the received information. Thus, a software program resident on the server is coded to take in the details from one or more users, assess the information received, and perform specific functions in response to the received information. The server may then supply information back to each client device to be displayed on a display screen of that client device as well as supply information back to one or more other networked users, such as the referring party, distributors, etc. The web application on the server can cooperate over a wide area network, such as the Internet or a cable network, with two or more client machines each having resident applications.

In an embodiment, the software used to facilitate the protocol and algorithms associated with the process can be embodied onto non-transitory machine-readable medium. A machine-readable medium includes any mechanism that provides (e.g., stores and/or transmits) information in a form readable by a machine (e.g., a computer). For example, a machine-readable medium includes read only memory (ROM); random access memory (RAM); magnetic disk storage media; optical storage media; flash memory devices; DVD's, EPROMs, EEPROMs, FLASH, magnetic or optical cards, or any type of media suitable for storing electronic instructions. The information representing the apparatuses and/or methods stored on the machine-readable medium may be used in the process of creating the apparatuses and/or methods described herein. Any portion of the server implemented in software and any software implemented on the client device are both stored on their own computer readable medium in a non-transitory executable format. Embodiments described herein, such as modules, applications, or other functions may be configured as hardware, software, or a combination thereof. The configuration may be stored one a single dedicated device such as an application locally resident and executed on mobile devices 110A-11C configured to communicate over a network or across many devices such as a website hosted across one or more servers 105A-C retrieving information across one or more databases 106A-C, to communicate across a network 100 to a local device, such as laptop 110B, or any combination thereof.

While some specific embodiments of the invention have been shown the invention is not to be limited to these embodiments. For example, most functions performed by electronic hardware components may be duplicated by software emulation, and vise verse. Thus, a software program written to accomplish those same functions may emulate the functionality of the hardware components in input-output circuitry. The invention is to be understood as not limited by the specific embodiments described herein, but only by scope of the appended claims.

For example, exemplary embodiments are provided in terms of one or more modules, functions, or interfaces. These modules, functions, or interfaces are explained as separate operating units for simplicity and are not intended to be so limited. Instead, these features may be combined, separated, integrated, or otherwise redefined in any configuration to perform one or more functions or attributes described herein. Therefore, different modules may perform one or more of the desired functions. The modules may be combined and integrated so that the two described modules are performed by a single module. Similarly, as recited in the claims, the indication of a first, second, or other object, feature, interface, module, etc. is intended to distinguish functions and does not indicate a quantity or separate entity. Instead, as long as one or more objects, features, interfaces, modules, etc. are present including the recited functions, the first, second, or other is present in the system.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

The invention claimed is:

1. An on-line purchasing platform, including a webpage resident on a server or a native mobile application resident on a client device configured to communicate with the server, where the webpage or native mobile application is configured to display one or more templates to a customer and receive input from a customer through the one or more templates and communicate the received input to the server, where the server is configured to cooperate with a database over a network, where the system comprises:
a first interface to receive an identifier from a customer;
a second unique interface associated to a party not the customer, wherein the party is associated with the identifier provided by the customer;
a third interface in which the customer may search for products, select products for purchase, or purchase products for sale.

2. The on-line purchasing platform of claim 1, wherein the first interface is displayed simultaneously on a same display as the second or third interface.

3. The on-line purchasing platform of claim 1, wherein the identifier uniquely identifies the party.

4. The on-line purchasing platform of claim 3, wherein the on-line purchasing platform tracks purchases made by the customer to determine a reward to the party.

5. The on-line purchasing platform of claim 4, wherein the identifier is a phone number associated with the party.

6. The on-line purchasing platform of claim 4, wherein the platform is configured such that if a customer navigates to the third interface to purchase products, the customer is prompted to enter the identifier after selecting products.

8. The on-line purchasing platform of claim 4, wherein the platform is configured such that the first interface is presented first to a customer and after entry of the identifier the second interface is presented to the customer.

9. The on-line purchasing platform of claim 8, wherein the platform is configured such that the third interface is presented to the customer if a customer does not provide the identifier through the first interface, and the second interface is not displayed to the customer.

10. The on-line purchasing platform of claim 4, wherein the platform is configured to provide information about purchases associated with the identifier to the party.

11. The on-line purchasing platform of claim 4, wherein the platform is configured to present the first, second, or third interface to a user first based on restrictions governing interactions with users in a geographic location of the user.

12. A method of on-line purchasing, comprising:
receiving an identifier from a referring party, where the referring party is associated with select services;
navigating to an electronic purchasing interface to buy products relevant to the select services of the referring party;
entering in the identifier to receive a discount on the products bought through the electronic purchasing interface;
rewarding the referring party based on the products bought through the electronic purchasing interface.

13. The method of on-line purchasing of claim 12, further comprising navigating to a customized interface associated with the referring party based on the identifier received.

14. The method of on-line purchasing of claim 13, further comprising creating a purchasing report to provide to the referring party based on the products bought through the electronic purchasing interface associated with the identifier.
